(19) United States
(12) Patent Application Publication
(10) Pub. No.: US 2005/0233207 A1
(43) Pub. Date: Oct. 20, 2005

(54) Electrolyte for lithium ion battery to control swelling

(75) Inventor: Nam In Kim, Buk-gu (KR)

Correspondence Address: R. Neil Sudol, 14 Colorado Avenue, Bridgeport, CT, 06605-1601, US

(73) Assignee: E SQUARE TECHNOLOGIES CO, LTD., GWANGSAN-GU (KR)

(21) Appl. No.: 10/859,774

(22) Filed: Jun. 3, 2004

(30) Foreign Application Priority Data
Apr. 16, 2004 (KR) 10-2004-0026352

(51) Int. Cl. H01M 2/26

(52) U.S. Cl. 429/122; 429/188; 429/322; 429/323

(57) ABSTRACT

Disclosed is an electrolyte for a lithium-ion secondary battery comprising an additive to prevent swelling of the battery caused by a gas generated in the battery upon storage at a high temperature, thereby inhibiting destruction of the SEI layer. According to the present invention, there is provided an electrolyte for a lithium-ion battery using any one of LiCoO₂, LiMn₂O₄, LiNiO₂, or a composite compound (LiMₓN_{y}O₂), wherein M and N are a metal element; and x and y are a rational number from 0 to 2, as an anodic active material, and crystalline or amorphous carbon or lithium as a cathodic active material, in which the electrolyte comprises: a mixed solvent comprising at least one carbonate type solvent; at least one lithium salt of LiPF₆, LiBF₄, LiClO₄, LiN(SO₂CF₃)₂ and LiN(SO₂CF₂CF₃)₂ as an electrolytic salt; and a mixed additive of 2-sulfobenzoic acid cyclic anhydride and divinyl sulfone.

### BACKGROUND OF THE INVENTION

1. Field of the Invention

The present invention relates to an electrolyte for a lithium ion battery and an electrolyte additive therefor, and more particularly, to an electrolyte for a lithium ion battery which can improve charge/discharge properties, lifespan and temperature properties of the battery, and an electrolyte additive.

2. Background of the Related Art

The battery refers to a device for converting the chemical energy generated at the time of an electrochemical oxidation-reduction reaction of chemicals, which are contained in the battery, to electrical energy. According to its use characteristic, the battery is classified into a primary battery that has to be disposed when the energy in the battery is used up, and a secondary battery that is rechargeable.

With a rapid progress of electronics, communication and computer industries, the current technology of the related equipment follows a trend toward miniaturization, lightweightness and high performance and hence portable electronic appliances such as camcorders, mobile phones, notebook personal computers, etc. have been in popular use. There is thus a need for high performance lightweight and small-sized batteries that have longer lifespan with high reliability. In regard to this requirement, a lithium-ion battery is the very promising secondary battery.

In such a lithium secondary battery, an electrolyte should have a high ion conductance since the ion conductance has a great influence on charge/discharge properties of a battery and rapid discharge properties. Thus, the electrolyte should have a high dielectric constant and a low viscosity so that lithium ions readily move in the solution. Also, it should have a low freezing point since movement of ions is restricted when the electrolyte is solidified at a low temperature, whereby charge/discharge of the battery cannot be achieved.

Therefore, in the battery industries associated with lithium rechargeable batteries, experiments have been widely conducted to improve electrochemical properties of a battery by mixing a solvent having a high dielectric constant with a solvent having a low viscosity to increase ion conductance of an electrolyte, and also, experiments have been widely conducted to improve properties of a battery at a low temperature by mixing a solvent having a low freezing point (U.S. Pat. No. 5,639,575 (97', Sony), U.S. Pat. No. 5,525,443 (96', Matsushita). Further, researches are in progress to improve properties of an electrolyte by mixing a solvent having a high boiling point to increase high temperature stability.

Such an electrolyte is composed of a solvent and an electrolytic salt and may further comprise an additive to enhance properties of a battery or to improve related problems. At present, as the solvent, a nonaqueous mixed solvent composed of carbonates including EC (Ethylene carbonate), PC (Propylene Carbonate), DMC (Dimethyl Carbonate), EMC (Ethylmethyl Carbonate), DEC(Diethyl Carbonate) such as EC/DMC/EMC, EC/EMC/DEC, EC/DMC/EMC/PC and the like are widely used and as the electrolytic salt, LiPF₆, LiBF₄, LiClO₄, LiN(SO₂CF₃)₂ and LiN(SO₂CF₂CF₃)₂ are widely used.

Meanwhile, during the initial discharge of the lithium-ion secondary battery, lithium ions generated from the lithium oxide used as the positive electrode material migrate to a carbon (crystalline or amorphous) electrode used as the negative electrode material and are intercalated into the carbon electrode, upon which they react with the carbon because of their high reactivity to produce Li₂CO₃, Li₂O and LiOH, which form a thin film, a so-called SEI (Solid Electrolyte Interface) layer, on the surface of the negative electrode material. The SEI layer is one of the main factors which may exert influence on migration of ions and charges, causing a change in properties of a battery. It is known that properties of the produced film vary with the type of a solvent which is used as an electrolyte and properties of an additive.

When a lithium ion battery is used continuously for a long period of time or left to stand at a high temperature, a gas is generated, causing an increase in thickness of the battery, which is a so-called swelling (thickness increase) phenomenon. Here, the amount of the generated gas depends on the condition of the SEI and thus, in order to prevent the swelling phenomenon, it is desired to have a technology to induce stable formation of the SEI layer. As a method to solve the foregoing problem, there are proposed technologies to add additive to an electrolyte, controlling the SEI film.

However, most of the additives which have been disclosed up to date show several negative effects in terms of intrinsic basic properties of a secondary battery such as reduction in discharge capacity, deterioration of high discharge rate performance and the like, although they may achieve the swelling inhibiting effect to some degree while being left to stand at a high temperature.

Therefore, there is a demand of a novel additive or an additive combination which can improve swelling inhibiting effect, without deterioration of intrinsic properties required for a lithium secondary battery such as reduction of discharge capacity, deterioration of lifespan, deterioration of capacity recovery property and the like.

### SUMMARY OF THE INVENTION

Thus, the present invention has been made to solve the above problems occurring in the prior art, and it is an object of the present invention to provide an electrolyte for a lithium secondary battery which can reduce swelling at a high temperature as compared to the conventional additives and improve intrinsic properties of the lithium secondary battery such as charge/discharge properties, lifespan and temperature properties, particularly high discharge rate properties at low temperature, open circuit voltage reduction, and capacity recovery properties, and an additive therefor.

To achieve the above object, according to the present invention, there is provided an electrolyte for a lithium-ion battery which uses any one of LiCoO₂, LiMn₂O₄, LiNiO₂, or a composite compound (LiMₓN_{y}O₂), wherein M and N are a metal element; and x and y are a rational number from 0 to 2, as an anodic active material, and crystalline or amorphous carbon or lithium as a cathodic active material, in which the electrolyte comprises a mixed solvent of at least one of carbonate type solvents, at least one lithium salt of LiPF₆, LiBF₄, LiClO₄, LiN(SO₂CF₃)₂ and LiN(SO₂CF₂CF₃)₂ as an electrolytic salt, and a mixed additive of 2-sulfobenzoic acid cyclic anhydride and divinyl sulfone.

### BRIEF DESCRIPTION OF THE DRAWINGS

The above and other objects, features and advantages of the present invention will be apparent from the following detailed description of the preferred embodiments of the invention in conjunction with the accompanying drawing, in which:

FIG. 1 is a graph showing discharge capacity of the lithium ion batteries prepared according to Example 1, and Comparative examples 1, 2 and 3;

FIG. 2 is a graph showing lifespan of the lithium ion batteries prepared according to Example 1, and Comparative examples 1, 2 and 3;

FIG. 3 is a graph showing change in open circuit voltage of the lithium ion batteries prepared according to Example 1, and Comparative examples 1, 2 and 3, upon storage at a high temperature; and

FIG. 4 is a graph showing capacity recovery properties of the lithium ion batteries prepared according to Example 1, and Comparative examples 1, 2 and 3, after storage at a high temperature.

### DETAILED DESCRIPTION OF THE PREFERRED EMBODIMENT

Now, the present invention is described in detail.

The present invention is directed to an electrolyte for a lithium ion secondary battery comprising an additive to inhibit the destruction of a SEI layer, thereby preventing the battery from being swollen by a gas generated in the battery upon storage at a high temperature.

The present inventors disclosed an attempt to prevent the destruction of a SEI layer and thereby, inhibit swelling of a battery by adding 2-sulfobenzoic acid cyclic anhydride compound as an additive to an electrolyte, in U.S. patent application Ser. No. 10/487,929 (PCT Application No. PCT/KR01/01770). However, though the swelling inhibiting effect is obtained when the additive is used alone, the capacity maintaining performance upon long-term storage at a high temperature is not satisfactory.

In order to overcome the defects of the previous application, according to the present invention, 2-sulfobenzoic acid cyclic anhydride is not used alone but used in combination with divinyl sulfone to provide swelling inhibiting effect and to improve intrinsic properties of a secondary battery such as charge/discharge properties, lifespan, temperature property.

The lithium-ion battery to which the present invention is applicable uses at least one of LiCoO₂, LiMn₂O₄, LiNiO₂, or a composite compound (LiMₓN_{y}O₂) as an anodic active material, and crystalline or amorphous carbon or lithium as a cathodic active material, wherein M and N are a metal element; and x and y are a rational number from 0 to 2.

In the electrolyte of the present invention, the carbonate solvent is a mixed solvent comprising at least one carbonate selected from EC, DMC, EMC, PC and DEC, and the lithium salt is a solute of the electrolyte for a lithium-ion battery that comprises at least one selected from LiPF₆, LiBF₄, LiClO₄, LiN(SO₂CF₃)₂ and LiN(SO₂CF₂CF₃)₂ in a concentration of 0.5 to 2.0 M.

The additive used in the electrolyte for a lithium ion battery according to the present invention is a mixed additive comprising 2-sulfobenzoic acid cyclic anhydride (SBACA) and divinyl sulfone, each being represented by the formulae (I) and (II):

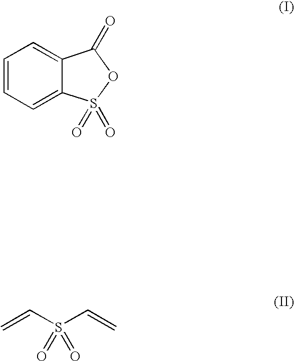

The 2-sulfobenzoic acid cyclic anhydride and the divinyl sulfone are added in an amount of 0.1 to 5.0 wt. %, respectively, based on the weight of the final electrolyte, preferably, 0.5 wt. %.

Although not generally used in the manufacture of a battery, the additive is employed for the special purposes to enhance the characteristics, for example, lifespan, high discharge rate at low temperature, high-temperature stability, prevention of overcharge and swelling at high temperature, etc. According to the present invention, the mixed additive of 2-sulfobenzoic acid cyclic anhydride and divinyl sulfone is used to prevent decomposition of the solvent by the destruction of the SEI layer upon storage at a high temperature, thereby inhibiting the swelling phenomenon and enhancing the performance of the battery.

Hereinafter, the present invention will be described in detail by way of the following examples and comparative Example, which are not intended to limit the scope of the present invention.

### EXAMPLE 1

0.21 kg of PVDF (Poly(vinylidene fluoride)) as a binder was dissolved in 3 kg of N-methyl-2-pyrrolydone (NMP) as a binder solvent to prepare a binder solution.

6.58 kg of LiCoO₂ as an anodic active material and 0.21 kg of a conductive agent were dry-mixed and 6.79 kg of the previously prepared binder solution was added thereto to prepare a slurry for an anode. The slurry was evenly coated on a 15 μm thick aluminum foil as a current collector for an anode, dried and rolled using a roll press to form an anode.

In order to prepare a cathode, 0.48 kg of PVDF as a binder was dissolved in 4.22 kg of NMP as a binder solvent to prepare a binder solution, similar to the method for the anode.

5.3 kg of carbon as a cathodic active material was mixed with the binder solution to prepare a slurry for a cathode. The slurry was coated on a 12 μm thick copper foil as a current collector for a cathode, dried and rolled using a roll press to form a cathode.

The anode, the cathode and a 25 μm thick polyethylene (PE)/polypropylene (PP) separator were wound up, compressed, and then wrapped with an aluminum laminate film to form a battery.

Subsequently, LiPF₆ as an electrolytic salt was dissolved in a solvent comprising EC, DMC and EMC (at a weight ratio of 1:1:1) to a concentration of 1.0M. To this solution were added 0.5 wt. % of 2-sulfobenzoic acid cyclic anhydride and 0.5 wt. % of divinyl sulfone, based on the weight of the final electrolyte respectively, to prepare an electrolyte, which was used to fabricate a battery.

### COMPARATIVE EXAMPLE 1

The procedures were performed in the same manner as described in Example 1, except that the additive was not used to prepare the electrolyte.

### COMPARATIVE EXAMPLE 2

The procedures were performed in the same manner as described in Example 1, except that, as an additive for the electrolyte, 2-sulfobenzoic acid anhydride was added in an amount of 2 wt. % based on the weight of the final electrolyte.

### COMPARATIVE EXAMPLE 3

The procedures were performed in the same manner as described in Example 1, except that, as an additive for the electrolyte, divinyl sulfone was added in an amount of 1 wt. % based on the weight of the final electrolyte.

### EXPERIMENTAL EXAMPLE 1

### Test of Swelling Inhibiting Effect

The batteries prepared in the above Example and Comparative Examples were charged under a constant current-constant voltage (CC-CV) condition using a current of 600 mA and a charge voltage of 4.2 V and kept for one hour. The batteries were discharged to 2.75 V with a current of 600 mA and kept for one hour.

After removal of a gas generated by vacuum, the batteries were again charged under a CC-CV condition using a current of 600 mA and a charge voltage of 4.2 V and kept for one hour. The batteries were discharged to 2.75 V with a current of 600 mA and kept for one hour.

This procedure was performed twice and the batteries were charged with a current of 600 mA and a charge voltage of 4.2 V for 3 hours.

To determine a change in thickness of the battery at high temperature, each of the charged batteries was measured for thickness and kept in a hot chamber at 85° C. for 4 days. After 4 hours and 96 hours, the measurement of the thickness was performed again and percentage to the thickness before storage at high temperature was calculated. The results are shown in Table 1.

As a result, Comparative Example 1, in which the additive was not used, showed a high thickness increase rate of about 37%, that is significant swelling phenomenon, while Comparative Example 2 and Comparative Example 3, in which 2-sulfobenzoic acid anhydride or divinyl sulfone was used alone, showed a significantly reduced thickness increase rate, as compared to Comparative Example 1. Particularly, Comparative Example 3, in which divinyl sulfone was used alone, showed excellent swelling inhibiting effect.

Also, Example 1, in which the mixed additive according to the present invention was used, showed a relatively low thickness increase rate, that is excellent swelling inhibiting effect.

TABLE 1

| | Thickness increase |
|---|---|
| | rate after storage at |
| | a high temperature |
| Electrolyte | for 4 hours (%) |
| Comparative Example 1 | 37.45 |
| Comparative Example 2 | 13.47 |
| Comparative Example 3 | 5.38 |
| Example 1 | 9.51 |

### EXPERIMENTAL EXAMPLE 2

### Test of Discharge Capacity

The batteries prepared in the above Example and Comparative Examples using different electrolytes were charged under a constant current-constant voltage (CC-CV) condition using a current of 600 mA and a charge voltage of 4.2 V and kept for one hour. The batteries were discharged to 2.75 V with a current of 600 mA and kept for one hour.

After removal of a gas generated by vacuum, the batteries were again charged under a CC-CV condition using a current of 600 mA and a charge voltage of 4.2 V and kept for one hour. The batteries were discharged to 2.75 V with a current of 600 mA and kept for one hour. Thus, the battery activation step was completed.

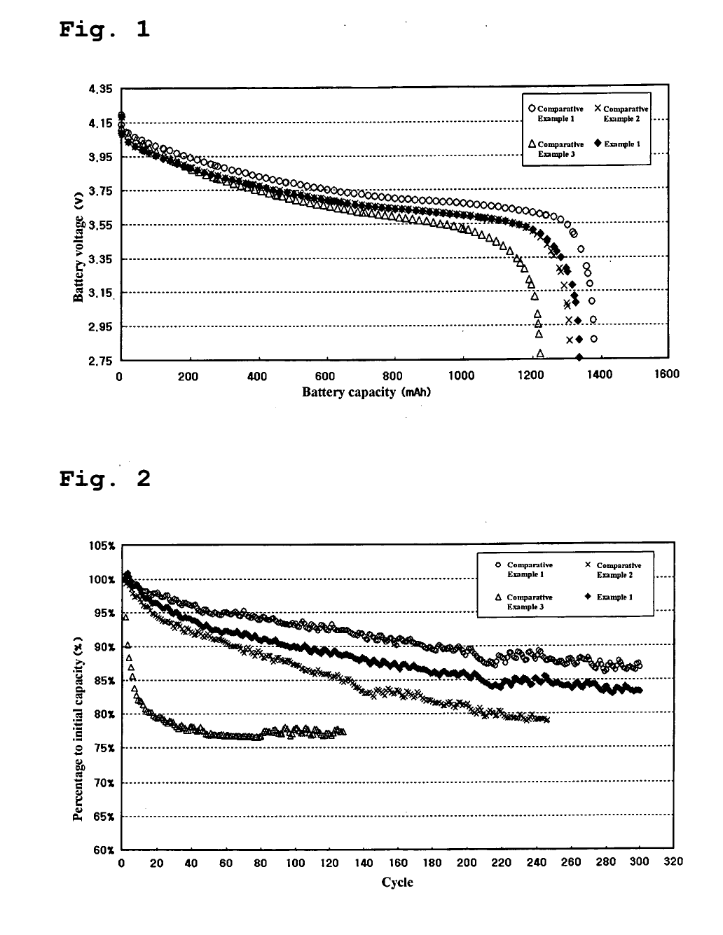

The activated batteries were charged under a CC-CV condition using a current of 600 mA and a charge voltage of 4.2 V for 2.5 and kept for 10 minutes. Then, the batteries were measured for the operation voltage and discharge capacity while being discharged with a current of 600 mA. The results are shown in FIG. 1.

As a result, Comparative Example 1, in which the additive was not added, showed a high operation voltage and discharge capacity. On the other hand, Comparative Example 3 which had shown the most excellent result in the thickness increase test, showed the lowest operation voltage and significant reduction in discharge capacity. Therefore, it was noted that Comparative Example 3 had excellent swelling inhibiting effect but deteriorated the battery properties. Example 1 according to the present invention showed a discharge capacity and operation voltage substantially similar to those of Comparative Example 1, in which the additive was not used, indicating that it has excellent discharge properties.

### EXPERIMENTAL EXAMPLE 3

### Lifespan Test

The batteries prepared in the above Example and Comparative Examples using different electrolytes were subjected to the activation process in the same manner as described in Experimental Example 2, charged using a current of 1200 mA and a charge voltage of 4.2 V and kept for 10 minutes. The batteries were discharged to a discharge ending voltage of 2.75 V with a current of 1200 mA and kept for 30 minutes.

This procedure was repeatedly performed several times to measure the capacity change of each battery as a percentage to the initial capacity and the results are shown in FIG. 2.

As a result, Comparative Example 3 showed serious capacity reduction as the lifespan increased while Comparative Example 1 and Example 1 according to the present invention showed excellent lifespan properties. Accordingly, it was noted that the additive according to the present invention has excellent lifespan properties.

### EXPERIMENTAL EXAMPLE 4

### Capacity Recovery Test

The batteries prepared in the above Example and Comparative Examples using different electrolytes were subjected to the capacity recovery test, as follows, to examine the properties after long-term storage at high temperature.

The batteries which had been subjected to the activation process in the same manner as described in Experiment Example 2 were charged using a current of 600 mA and a charge voltage of 4.2 V and kept for 10 minutes. The batteries were discharged to 2.75 V with the same current and measured for the capacity under the standard state.

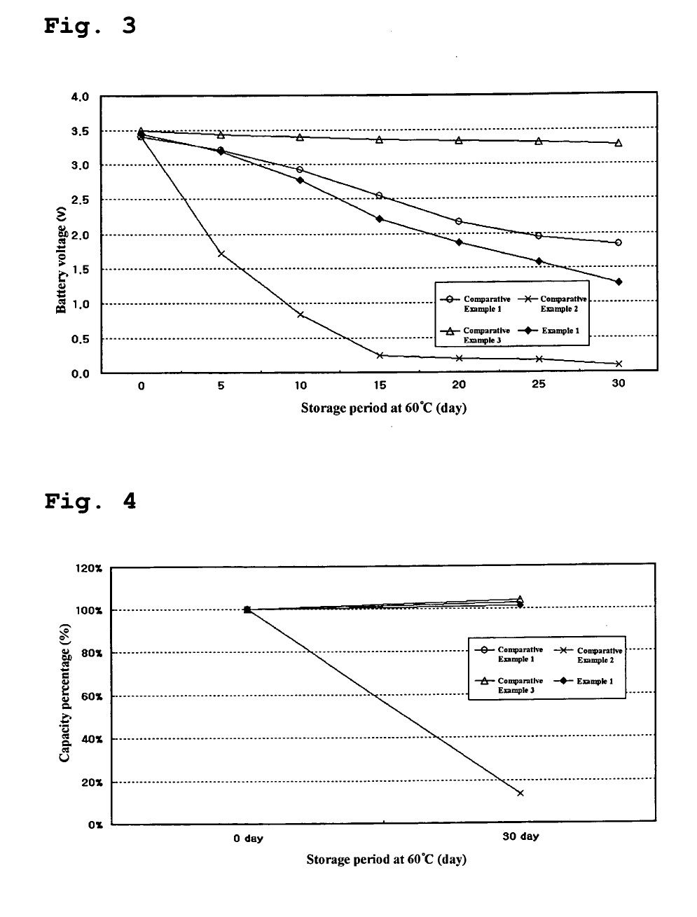

The discharged batteries were stored in a high temperature chamber set to 60° C. for 30 days. Every 5 days, the open circuit voltage was measured and the results are shown in FIG. 3.

Then, to determine the capacity recovery rate, the batteries which had been stored at a high temperature were charged using a current of 600 mA to a charge voltage of 4.2 V and discharged to 2.75 V with the same current. The recovery rate was calculated as a percentage to the standard capacity and the results are shown in FIG. 4.

As a result, all the electrolytes including the Example according the present invention, except for Comparative Example 2 showed 100% recovery rate. Accordingly, it was noted that the present invention is excellent in terms of the battery capacity recovery rate.

As can be seen from the results of the above Experimental Examples, it was noted that the mixed additive comprising 2-sulfobenzoic acid anhydride and divinyl sulfone according to the present invention significantly improves the problems involved in the conventional additive, including the reduction in discharge capacity, the deterioration in lifespan, the capacity recovery properties upon storage at high temperature.

As described above, according to the present invention, there is provided electrolyte for a lithium-ion battery which uses any one of LiCoO₂, LiMnO₂, LiMn₂O₄, LiNiO₂, or a composite compound (LiMₓN_{y}O₂), wherein M and N are a metal element; and x and y are a rational number from 0 to 2, as an anodic active material, and crystalline or amorphous carbon or lithium as a cathodic active material, in which the electrolyte comprises a mixed solvent of at least one of carbonate type solvents, at least one lithium salt of LiPF₆, LiBF₄, LiClO₄, LiN(SO₂CF₃)₂ and LiN(SO₂CF₂CF₃)₂ as an electrolytic salt, and a mixed additive of 2-sulfobenzoic acid cyclic anhydride and divinyl sulfone.

According to the present invention, it is possible to provide a novel electrolyte for a lithium secondary battery which can reduce swelling at high temperature, as compared to the conventional additives and improves intrinsic properties of the secondary battery such as charge/discharge properties, use-life properties, temperature properties, particularly high discharge rate properties at low temperature, open circuit voltage reduction and capacity recovery properties, and an additive therefor.

1. An electrolyte for a lithium-ion battery using any one of LiCoO₂, LiMn₂O₄, LiNiO₂, or a composite compound (LiMₓN_{y}O₂), wherein M and N are a metal element; and x and y are a rational number from 0 to 2, as an anodic active material, and crystalline or amorphous carbon or lithium as a cathodic active material, in which the electrolyte comprises:
a mixed solvent comprising at least one carbonate type solvent;
at least one lithium salt of LiPF₆, LiBF₄, LiClO₄, LiN(SO₂CF₃)₂ and LiN(SO₂CF₂CF₃)₂ as an electrolytic salt; and
a mixed additive of 2-sulfobenzoic acid cyclic anhydride of the formula (I) and divinyl sulfone of the formula (II).

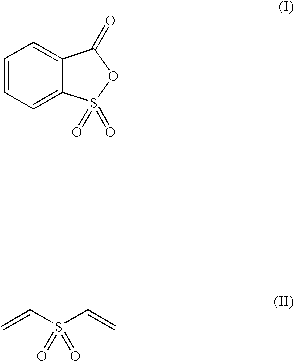

2. The electrolyte according to claim 1, in which the carbonate type solvent is selected from EC, DMC, EMC, PC and DEC.

3. The electrolyte according to claim 1, in which the lithium salt as an electrolytic salt has a concentration of 0.2 to 2.0M.

4. The electrolyte according to claim 1, in which the 2-sulfobenzoic acid cyclic anhydride and the divinyl sulfone are added in an amount of 0.1 to 5.0 wt. %, respectively, based on the weight of the final electrolyte.
